(19) United States
(12) Patent Application Publication
(10) Pub. No.: US 2004/0264391 A1
(43) Pub. Date: Dec. 30, 2004

(54) Method of full-duplex recording for a communications handset

(75) Inventors: Ali Behboodian, Plantation, FL (US); Scott D. Koenigsman, Ft. Lauderdale, FL (US); Daniel J. Landron, Plantation, FL (US); Chin P. Wong, Coral Springs, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/606,692

(22) Filed: Jun. 26, 2003

(51) Int. Cl. H04B 1/56; H04L 5/14

(52) U.S. Cl. 370/276

(57) ABSTRACT

A method of full-duplex recording for a communications handset includes steps of receiving a first stream of encoded information frames, receiving a stream of information samples, encoding the stream of information samples to generate an additional stream of encoded information frames, and generating a single stream of encoded information frames from the first stream of encoded information frames and the additional stream of encoded information frames.

### BACKGROUND OF THE INVENTION

1. Field of the Invention

The present invention is directed to a wireless infrastructure for providing Location Enhanced Services such as iDEN (Integrated Digital Enhanced Network) that combines two-way digital radio, digital wireless telephone, alphanumeric messaging, data/fax capabilities, and other wireless services leveraging Internet access technology in a pocket-sized digital handset. More specifically, but without limitation thereto, the present invention is directed to a method of recording conversations for an iDEN handset.

2. Description of the Prior Art

A recently introduced feature of iDEN handsets provides the capability of recording conversations during an interconnect call. The user may then play back the recorded conversation later from the iDEN handset.

### DESCRIPTION OF THE DRAWINGS

The present invention is illustrated by way of example and not limitation in the accompanying figures, in which like references indicate similar elements throughout the several views of the drawings, and in which:

FIG. 1 illustrates the information content of a typical recorded conversation of the prior art;

FIG. 2 illustrates a hypothetical solution to full duplex recording of interconnect calls in an iDEN infrastructure;

FIG. 3 illustrates a block diagram of a full duplex recorder for an iDEN handset according to an embodiment of the present invention;

FIG. 4 illustrates an example of the operation of the full duplex recorder of FIG. 3;

FIG. 5 illustrates a flow chart for a method of multiplexing audio channels into a single stream for a communications device recorder according to an embodiment of the present invention;

FIG. 6 illustrates a flow chart for a method of playing back the stream of multiplexed audio channels recorded in FIG. 5; and

FIG. 7 illustrates a flow chart for a method of full-duplex recording and playback according to an embodiment of the present invention.

To simplify referencing in the description of the illustrated embodiments of the present invention, indicia in the figures may be used interchangeably to identify both the signals that are communicated between the elements and the connections that carry the signals.

Elements in the figures are illustrated for simplicity and clarity and have not necessarily been drawn to scale. For example, the dimensions of some elements in the figures may be exaggerated relative to other elements to point out distinctive features in the illustrated embodiments.

### DESCRIPTION OF THE ILLUSTRATED EMBODIMENTS

Although speech information signals are used herein to illustrate embodiments of the present invention, any information signal may be used in conjunction with the appropriate encoding, decoding, and playback devices for converting the playback information frames to sensible signals to practice the present invention within the scope of the appended claims. Also, the specific references to iDEN handsets are intended to include other communications devices suitable for practicing various embodiments of the present invention within the scope of the appended claims. Examples of such other devices include, but are not limited to, cellular telephones, two-way radios, personal computers, and personal digital assistants.

In a wireless infrastructure such as iDEN (Integrated Digital Enhanced Network), wireless devices are associated with individual subscribers. An iDEN infrastructure combines two-way digital radio, digital wireless telephone, alphanumeric messaging, data/fax capabilities, and other wireless services leveraging Internet access technology in a pocket-sized digital handset. For example, an iDEN handset may record a conversation during an interconnect call that may be played back later at the user's convenience. Disadvantageously, however, previous recording methods only record the conversation from the far end and do not include the side of the conversation at the near end where the recording is made. Another disadvantage of previous methods is that silences in the far end signal are recorded, so that the recorded conversation will have gaps both when the far end user is not speaking and when the near end user is speaking.

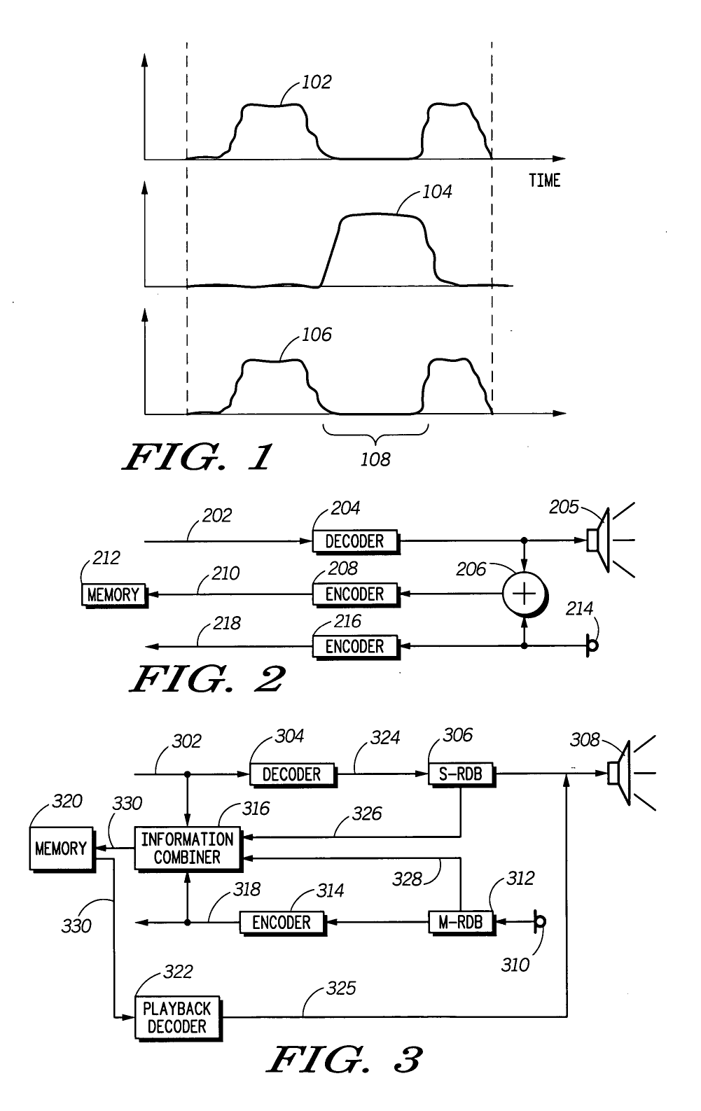

FIG. 1 illustrates the information content of a typical recorded conversation of the prior art. Shown in FIG. 1 are a far end information signal 102, a near end information signal 104, a recorded signal 106, and a silence period 108.

The far end information signal 102 and the near end information signal 104 may be, for example, speech, music, and other types of signals that may be used to convey information and may originate from any communication device, for example, an iDEN handset or a landline telephone. In the example of FIG. 1, the far end information signal 102 from the far end user has two active periods and one silence period 108. In this example, the far end information signal 102 and the near end information signal 104 are independent from each other and either signal may be active at any time. The recorded signal 106 is identical to the far end information signal 102 and includes the period during which the near end information signal 104 from the near end user is active. However, only the far end information signal 102 from the far end user is recorded regardless of who is transmitting, even if the far end user is only listening to the near end user. This mode of recording is called simplex recording. A substantial improvement would be to record both sides of the conversation even if both users are talking at the same time, that is, full-duplex recording, especially if the recorded conversation is to be played back for a third party, for example, for a transcriber of the conversation.

In digital cellular telephone communication, speech is encoded before transmission over the air and is decoded either in the wireless subscriber unit or in the wireless infrastructure. Encoded speech is a data stream that is the result of compressing the speech signal by the speech encoder. The speech decoder decompresses the encoded speech signal. One possible method of full duplex recording would utilize two speech encoders.

FIG. 2 illustrates a hypothetical solution to full-duplex recording of interconnect calls in an iDEN handset. Shown in FIG. 2 are encoded speech from the wireless infrastructure 202, a speech decoder 204, a loudspeaker 205, a mixer 206, a first encoder 216, full-duplex encoded speech 210, a memory 212, a microphone 214, a second encoder 208, and encoded speech 218 from the near end handset.

In the arrangement of FIG. 2, the encoded speech from the far end wireless infrastructure 202 is decoded by the speech decoder 204 and converted to audio waves at the near end handset by the loudspeaker 205. Other components typically used for converting digital signals to analog signals have been omitted to simplify the illustration. The decoded speech from the wireless infrastructure 202 and the signal from the microphone 214 in the near end handset are combined by the mixer 206 and encoded by the second encoder 208, resulting in the full-duplex encoded speech 210 that is recorded in the memory 212 of the near end handset. The signal from the microphone 214 is also encoded by the first encoder 216 and transmitted as encoded speech 218 from the near end handset to the wireless infrastructure 202. Unfortunately, however, this solution is impractical due to the high resource demands of the speech encoding algorithm on the digital signal processing unit (DSP) in the near end iDEN handset. Adding another encoder is therefore not a viable solution to full-duplex recording in the current iDEN infrastructure.

While encoding an information signal requires a relatively large amount of digital signal processor time, decoding an information signal requires a relatively small amount of digital signal processor time. A practical solution to the problem of full-duplex recording of a conversation in iDEN handsets may therefore be implemented by adding an information combiner as follows.

In one aspect of the present invention, a full duplex recorder for a communications device includes an information combiner for receiving a first stream of encoded information frames and an additional stream of encoded information frames to generate a single stream of encoded information frames and an encoder for receiving a stream of information samples and for generating the additional stream of encoded information frames.

FIG. 3 illustrates a block diagram of a full-duplex recorder for an iDEN handset according to an embodiment of the present invention. Shown in FIG. 3 are a first stream of encoded information frames 302, a decoder 304, a speaker record decision block (S-RDB) 306, a sensible output signal converter 308, a sensible input signal converter 310, a microphone record decision block (M-RDB) 312, an encoder 314, an information combiner 316, an additional stream of encoded information frames 318, a memory 320, a playback decoder 322, a stream of decoded information frames 324, a stream of decoded information samples 325, a speaker record decision signal 326, a microphone record decision signal 328, and a single stream of recorded information frames 330.

The speaker record decision block (S-RDB) 306 and the microphone record decision block (M-RDB) 312 are optional and may be implemented, for example, respectively as voice activity detectors M-VAD and S-VAD in the digital signal processor of the near end IDEN handset according to well known techniques. The sensible output signal converter 308 may be, for example, an audio output circuit and loudspeaker, and the sensible input signal converter 310 may be, for example, an audio input circuit and microphone such as found in a typical iDEN handset. Other types of circuits may be used to convert between digital information signals and sensible signals, that is, signals that may be perceived by a user, according to well-known techniques.

The stream of input encoded information frames 302 is received, for example, by a near end iDEN handset during an interconnect call. The decoder 304 may be implemented, for example, as a speech decoder in the digital signal processor of the near end iDEN handset according to well-known techniques to generate the stream of decoded information frames 324 from the first stream of encoded information frames 302. The stream of decoded information frames 324 is converted, for example, into a sensible audio signal by the sensible output signal converter 308. If the speaker record decision block (S-RDB) 306 is implemented, the speaker record decision signal 326 is generated as a function of the probability of the presence of speech in the stream of decoded information frames. For example, the speaker record decision signal 326 may be set to zero for a low probability of the presence of speech and to one for a high probability of the presence of speech. The thresholds that determine what is a low probability and what is a high probability may be selected to suit specific applications to practice the invention within the scope of the appended claims. Alternatively, the energy level present in the stream of decoded information frames may be used to determine the value of the speaker record decision signal 326.

The sensible input signal converter 310 generates a stream of information samples, for example, from speech received by a microphone in the near end iDEN handset. If the microphone record decision block (M-RDB) 312 is implemented, the microphone record decision signal 328 is generated as a function of the probability of speech in the stream of information samples as described above for the speaker record decision block (S-RDB) 306. The encoder 314 may be implemented, for example, as a speech encoder in the digital signal processor of the near end iDEN handset according to well-known techniques. The encoder 314 encodes the stream of information samples from the sensible input signal converter 310 and generates the additional stream of encoded information frames 318 that is transmitted to the far end according to well-known techniques.

During full-duplex recording, the information combiner 316 receives the first stream of encoded information frames 302, the additional stream of encoded information frames 318, and optionally one or both of the record decision signals 326 and 328 if the corresponding one or both of the speaker record decision block (S-RDB) 306 and the microphone record decision block (M-RDB) 312 are implemented. The information combiner 316 sets an overlap flag in each information frame of the first stream of encoded information frames 302 and/or the additional stream of encoded information frames 318 in which the probability of voice activity in both the first stream of encoded information frames 302 and the additional stream of encoded information frames 318 exceeds a selected threshold at the same sample time. The information combiner 316 then interleaves the first stream of encoded information frames 302 and the additional stream of encoded information frames 318 into the single stream of encoded information frames 330, and stores the single stream of encoded information frames 330 in the memory 320. The memory 320 may be, for example, a portion of the computer memory in the near end iDEN handset used for recording. In this example, only two streams of encoded information frames are interleaved to generate the single stream of recorded encoded information frames 330; however, additional streams of encoded information frames may be interleaved by the information combiner 316 in the same manner to generate the single stream of recorded encoded information frames in other embodiments to practice the invention within the scope of the appended claims.

During full-duplex playback, the playback decoder 322 retrieves the recorded encoded information frames 330 from the memory 320. If the speaker record decision block (S-RDB) 306 and the microphone record decision block (M-RDB) 312 are not implemented, then the playback decoder 322 decodes the encoded information frames 330. The decoded information frames associated with the same sample time are combined to generate mixed information frames in the stream of decoded information samples 325. The mixed information frames include speech from both the decoded speaker frames and the decoded microphone frames as it would be heard in a full-duplex communication. The stream of decoded information samples 325 may be buffered according to well-known techniques and converted to a sensible signal, for example, an audio signal, by the sensible output signal converter 308.

If one or both of the speaker record decision block (S-RDB) 306 and the microphone record decision block (M-RDB) 312 are implemented, then the playback decoder 322 decodes the stream of recorded encoded information frames 330 and checks the overlap flag in the decoded information frames associated with the same sample time. If the overlap flag is set in at least one of the decoded information frames associated with the same sample time, then the playback decoder 322 adds the decoded information frames to generate a mixed information frame. The playback decoder 322 buffers the mixed information frame for playback as described above. If the overlap flag is not set, then the playback decoder 322 concatenates both decoded information frames and buffers them for playback as described above.

In another embodiment of the present invention, if the overlap flag is set in at least one of the decoded information frames associated with the same sample time, then the playback decoder 322 separates the decoded information frames so that overlapping portions of the conversation are distinct from one another. For example, if the stream of input encoded information frames 302 contains the phrase “. . . times the square of the hypotenuse” within the same time interval that the stream of output encoded information frames 318 contains the phrase “I can't hear you”, then the playback decoder 322 buffers decoded information frames only from the stream of input encoded speaker frames 302 until a silence or other suitable break is determined from the overlap flags in the stream of input encoded speaker frames 302. At the break, the playback decoder 322 buffers decoded information frames only from the stream of output encoded information frames 318 until a silence or other suitable break is determined from the overlap flags in the stream of output encoded information frames 318. In this example, the phrase “. . . times the square of the hypotenuse” would be completed before starting the phrase “I can't hear you”. This feature avoids losing pieces of conversation due to interference, a frequent problem encountered during transcribing a conversation.

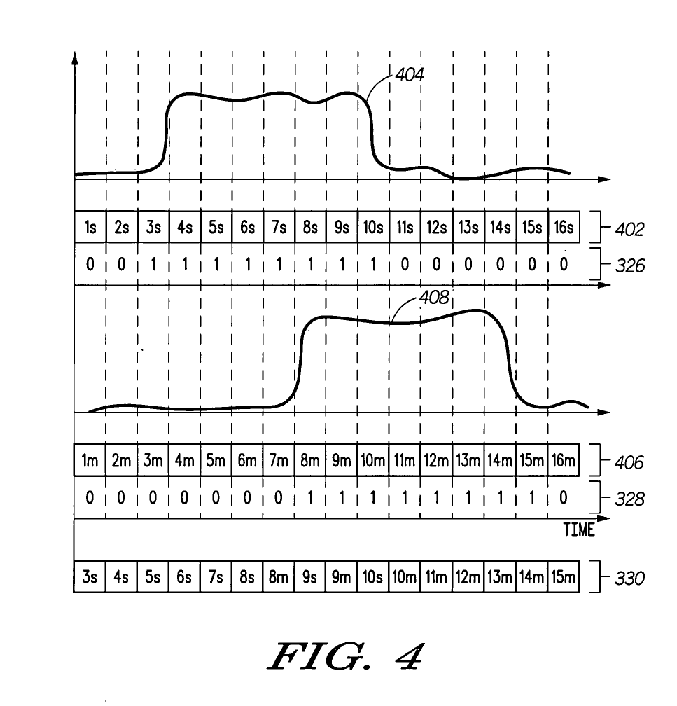

FIG. 4 illustrates an example of the operation of the full-duplex recorder of FIG. 3. Shown in FIG. 4 are a first stream of encoded information frames 402, a corresponding indication of presence of speech 404 in the stream of decoded information frames, a speaker record decision signal 326, a stream of information samples 406, a corresponding indication of presence of speech 408 in the information samples 406, a microphone record decision signal, 328, and a single stream of encoded information frames 330.

The signal received from the far end is represented by the first stream of encoded information frames 402. For the frames in the first stream of encoded information frames 402, there is a corresponding probability of presence of speech 404 that, for example, has a high level when the user at the far end is speaking and has a low level when the user at the far end is not speaking. The record decision signal 326 may be generated, for example, by a voice activity detector, or S-VAD (Speaker Voice-Activity Detector) according to well-known techniques. In this example, the speaker record decision signal 326 is cleared, represented by zeroes, when the probability of presence of speech detected in the stream of decoded information frames is below a selected threshold to indicate that the user at the far end is not speaking, however, other methods of indicating that the user at the far end is not speaking may also be used to practice the present invention within the scope of the appended claims. The speaker record decision signal 326 is set, represented by ones, when the probability of presence of speech detected in the stream of decoded information frames is above a selected threshold to indicate that the user of the far end iDEN handset is speaking.

The signal received from the near end iDEN handset is represented by the additional stream of encoded information frames 406. For the additional stream of encoded information frames 406, there is an indication of presence of speech that for example has a high level when the user of the near end iDEN handset is speaking and has a low level when the user of the near end iDEN handset is not speaking. The record decision signal 328 may be generated, for example, by a voice activity detector, or M-VAD (Microphone Voice-Activity Detector) according to well-known techniques. For example, the record decision signal 328 may be cleared, represented by zeroes, when the probability of presence of speech detected in the stream of information samples 408 is below a selected threshold to indicate that the user of the near end iDEN handset is not speaking. The record decision signal 328 may be set, represented by ones, when the probability of presence of speech detected in the stream of information samples 408 is above a selected threshold to indicate that the user of the near end iDEN handset is speaking.

Each of the information frames in the single stream of encoded information frames 330 generated by the information combiner 316 includes a speaker/microphone flag to indicate which one of the first and the additional encoded information streams was selected and an overlap flag to indicate that multiple information streams are to be mixed or separated.

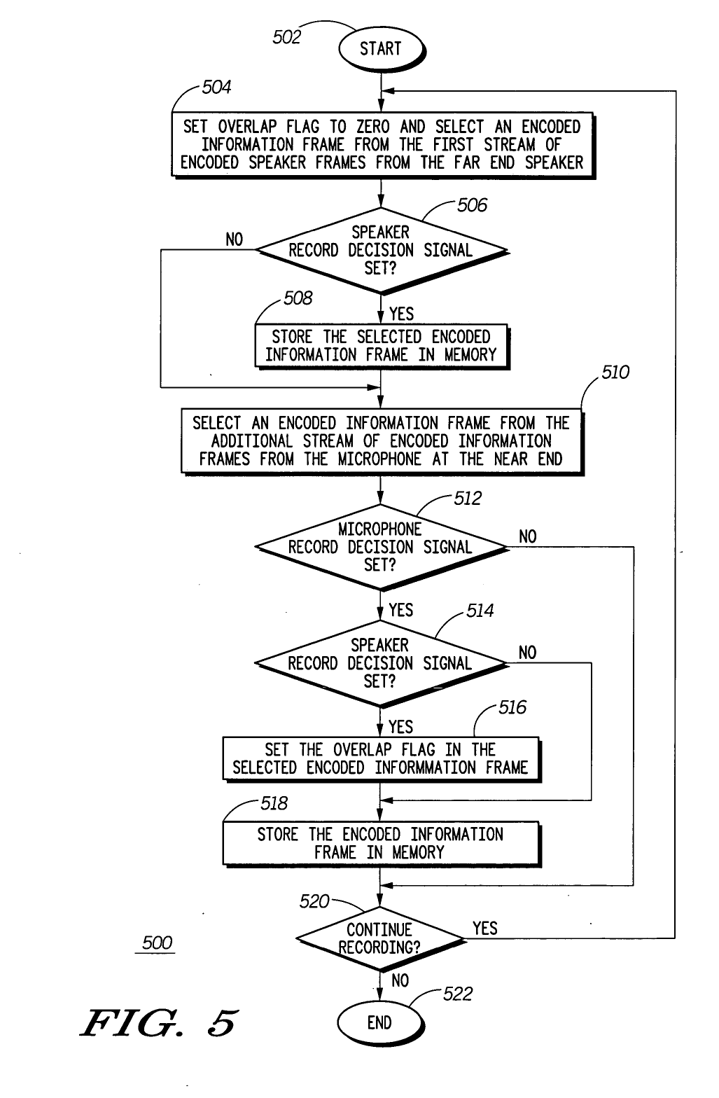

FIG. 5 illustrates a flow chart 500 for a method of multiplexing audio channels into a single stream for a communications device recorder according to an embodiment of the present invention.

Step 502 is the entry point of the flow chart 500.

In step 504, an overlap flag is set to zero and an encoded information frame is selected from the first stream of encoded information frames coming from the far end speaker.

In step 506, if the speaker record decision signal is set, indicating that a speech signal is present in the first stream of encoded information frames, then control is transferred to step 508. Otherwise, control is transferred to step 510.

In step 508, the encoded information frame selected in step 504 is stored in memory.

In step 510, an encoded information frame is selected from the additional stream of encoded information frames coming from the microphone at the near end.

In step 512, if the microphone record decision signal is set, indicating that a speech signal is present in the additional stream of encoded information frames, then control is transferred to step 514. Otherwise, control is transferred to step 518.

In step 514, if the speaker record decision signal is set, then control is transferred to step 516. Otherwise, control is transferred to step 518.

In step 516, the overlap flag is set in the encoded information frame selected in step 510.

In step 518, the encoded information frame selected in step 510 is generated as output in the single stream of encoded information frames and stored in memory.

In step 520, if continued recording is desired, then control is transferred to step 504. Otherwise, control is transferred to step 522.

Step 522 is the exit point of the flow chart 500.

Once the single stream of encoded information frames has been stored in memory, the stream of recorded encoded information frames may be played back as follows.

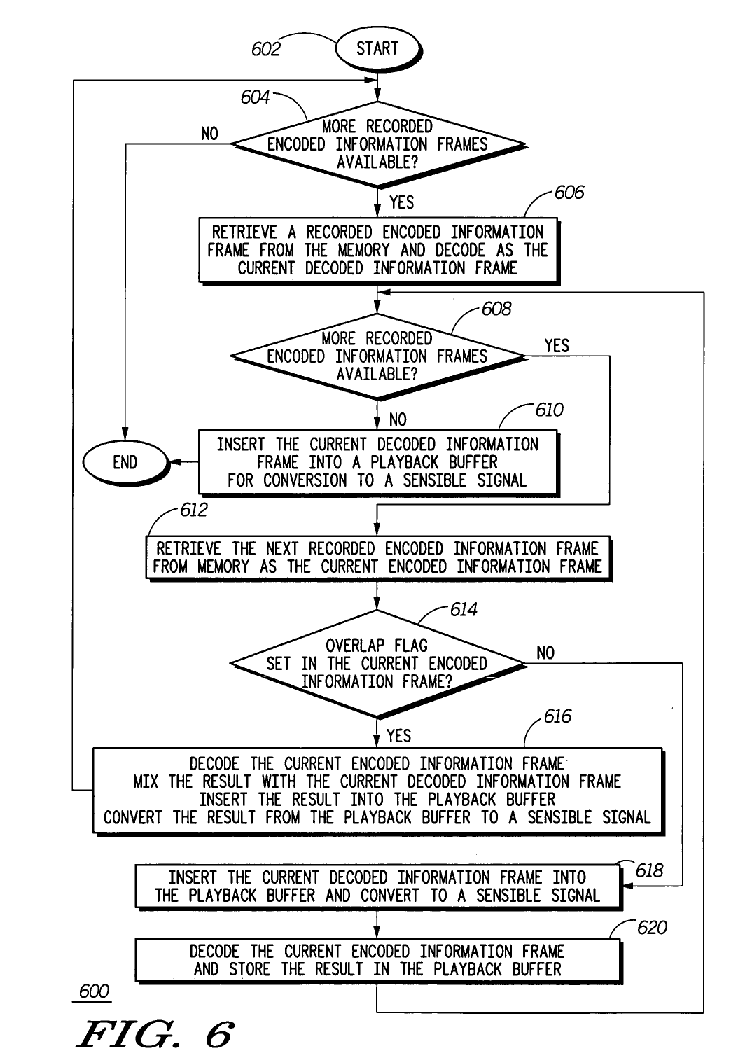

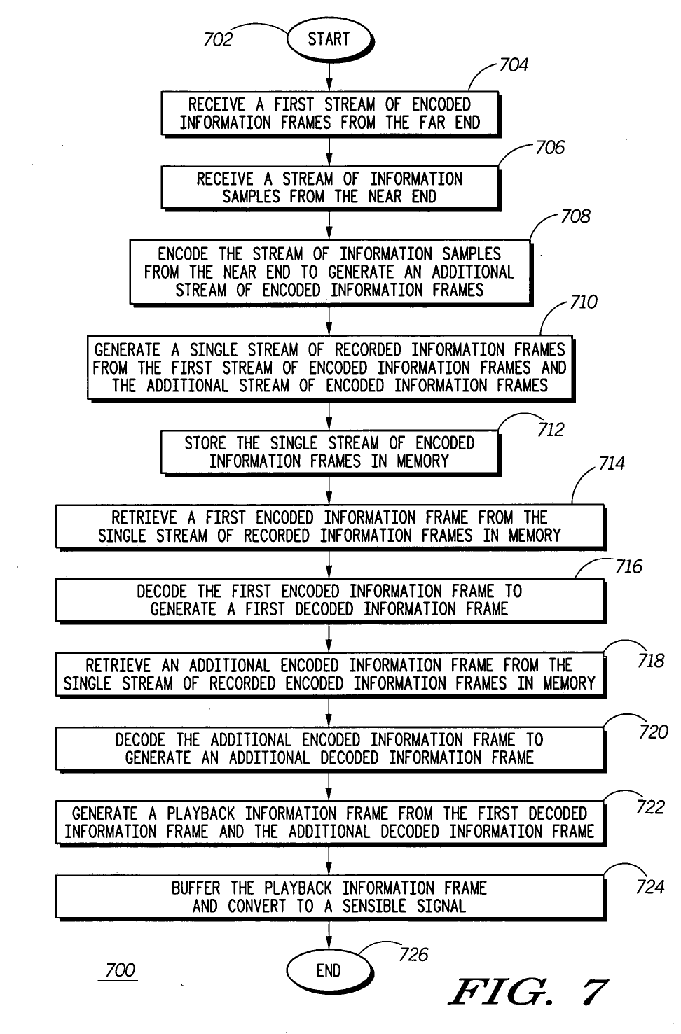

FIG. 6 illustrates a flow chart for a method of playing back the stream of multiplexed audio channels recorded in FIG. 5.

Step 602 is the entry point of the flow chart 600.

In step 604, if no further recorded encoded information frames are available, control is transferred to step 622.

In step 606, a recorded encoded information frame is retrieved from the memory and decoded. The result is designated as the current decoded information frame.

In step 608, if no further recorded encoded information frames are available, control is transferred to step 610. Otherwise, control is transferred to step 612.

In step 610, the current decoded information frame is inserted into a playback buffer for conversion to a sensible signal, such as audio waves from a loudspeaker. Control is then transferred to step 622.

In step 612, the next recorded encoded information frame is retrieved from the memory and designated as the current encoded information frame.

In step 614, if the overlap flag is set in the current encoded information frame, control is transferred to step 616. Otherwise, control is transferred to step 618.

In step 616, the current encoded information frame is decoded and designated as the new decoded information frame. The new decoded information frame is mixed with the current decoded information frame, and the result is inserted into the playback buffer and converted into a sensible signal. The mixed result may be, for example, a simple addition, or it may be a weighted sum, such as 20 percent of the value of the new decoded information frame added to 80 percent of the value of the current decoded information frame. Control is then transferred to step 604.

In step 618, the current decoded information frame is inserted into the playback buffer and converted into a sensible signal.

In step 620, the current encoded information frame is decoded and the result is stored in the playback buffer. Control is then transferred to step 608.

Step 622 is the exit point of the flow chart 600.

In another aspect of the present invention, a method of full-duplex recording for a communications device includes steps for receiving a first stream of encoded information frames, receiving a stream of information samples, encoding the stream of information samples to generate an additional stream of encoded information frames, and generating a single stream of encoded information frames from the first stream of encoded information frames and the additional stream of encoded information frames.

FIG. 7 illustrates a flow chart of a method of full-duplex recording and playback according to an embodiment of the present invention.

Step 702 is the entry point of the flow chart 700.

In step 704, a first stream of encoded information frames is received, for example, from a far end Iden handset.

In step 706, a stream of information samples is received, for example, from a microphone in a near end Iden handset.

In step 708, the stream of information samples is encoded to generate an additional stream of encoded information frames.

In step 710, a single stream of information frames is generated from the first stream of encoded information frames and the additional stream of encoded information frames. The single stream of recorded information frames may be selected from either the first stream of encoded information frames or the additional stream of encoded information frames, or the single stream of recorded information frames may be interleaved and flagged from the first stream of encoded information frames and the additional stream of encoded information frames as described above.

In step 712, the single stream of recorded information frames is stored in memory.

In step 714, a first encoded information frame is retrieved from the single stream of recorded encoded information frames in memory.

In step 716, the first encoded information frame is decoded to generate a first decoded information frame.

In step 718, an additional encoded information frame is retrieved from the single stream of recorded encoded information frames in memory.

In step 720, the additional encoded information frame is decoded to generate an additional decoded information frame.

In step 722, a playback information frame is generated from the first decoded information frame and the additional decoded information frame depending on the value of the flag set in either of the encoded information frames. The playback information frame may be representative of an information frame in either the first stream of encoded information frames or the additional stream of encoded information frames, or the playback information frame may be representative of a mix of an information frame in the first stream of encoded information frames and an information frame in the additional stream of encoded information frames, or the playback information frame may be representative of a concatenation of an information frame from the first stream of encoded information frames and an information frame from the additional stream of encoded information frames. Alternatively, the playback information frame may also be generated by any other desired function of the first stream of encoded information frames and the additional stream of encoded information frames.

In step 724, the playback information frame is buffered and converted to a sensible signal, such as audio waves from a loudspeaker.

Step 726 is the exit point of the flow chart 700.

Although the method of the present invention illustrated by the flowchart descriptions above is described and shown with reference to specific steps performed in a specific order, these steps may be combined, sub-divided, or reordered without departing from the scope of the claims. Unless specifically indicated herein, the order and grouping of steps is not a limitation of the present invention.

While the invention herein disclosed has been described by means of specific embodiments and applications thereof, numerous modifications and variations may be made thereto by those skilled in the art without departing from the scope of the invention set forth in the following claims.

What is claimed is:

1. A method of full-duplex recording for a communications handset comprising steps of:
receiving a first stream of encoded information frames;
receiving a stream of information samples;
encoding the stream of information samples to generate an additional stream of encoded information frames; and
generating a single stream of encoded information frames from the first stream of encoded information frames and the additional stream of encoded information frames.

2. The method of claim 1 wherein each frame in the single stream of encoded information frames includes a flag for selecting how frames in the single stream of encoded information frames will be used for playback.

3. The method of claim 2 further comprising a step of storing the single stream of encoded information frames in memory.

4. The method of claim 1 wherein the step of generating a single stream of encoded information frames comprises generating a speaker record decision signal.

5. The method of claim 4 wherein the speaker record decision signal is a voice activity signal generated as a function of the additional stream of encoded information frames or the first stream of encoded information frames or the stream of information samples.

6. The method of claim 4 wherein the step of generating the single stream of encoded information frames comprises selecting an encoded information frame from the first stream of encoded information frames in response to the speaker record decision signal.

7. The method of claim 4 wherein the speaker record decision signal is a voice activity signal generated as a function of a stream of samples decoded from the first stream of encoded information frames.

8. The method of claim 1 wherein the step of generating a single stream of encoded information frames comprises a step of generating a microphone record decision signal.

9. The method of claim 8 wherein the microphone record decision signal is a voice activity signal generated as a function of the stream of information samples or the first stream of encoded information frames or the additional stream of encoded information frames or a stream samples decoded from the first stream of encoded information frames.

10. The method of claim 8 wherein the step of generating the single stream of encoded information frames comprises selecting an encoded information frame from the additional stream of encoded information frames in response to the microphone record decision signal.

11. The method of claim 10 wherein the step of generating the single stream of encoded information frames comprises setting an overlap flag in an encoded information frame in the single stream of encoded information frames in response to at least one of the microphone record decision signal and a speaker record decision signal.

12. The method of claim 1 further comprising steps of:
retrieving a first recorded encoded information frame from the single stream of recorded encoded information frames;
decoding the first recorded encoded information frame to generate a first decoded information frame;
retrieving an additional recorded encoded information frame from the single stream of recorded encoded information frames;
decoding the additional recorded encoded information frame to generate an additional decoded information frame; and
generating a playback information frame from the first decoded information frame and the additional decoded information frame.

13. The method of claim 12 wherein the step of generating a playback information frame comprises mixing the first decoded information frame and the additional decoded information frame.

14. The method of claim 12 wherein the step of generating a playback information frame comprises concatenating the first decoded information frame and the additional decoded information frame.

15. The method of claim 12 further comprising a step of buffering the playback information frame.

16. The method of claim 15 further comprising a step of converting the playback information frame to a sensible signal.

17. A full duplex recorder for a communications device comprising:
an encoder for receiving a stream of information samples and for generating a first stream of encoded information frames; and
an information combiner coupled to the encoder for receiving an additional stream of encoded information frames and the first stream of encoded information frames to generate a single stream of encoded information frames.

18. The full duplex recorder of claim 17 further comprising a decoder for receiving the additional stream of encoded information frames and for generating a stream of decoded information frames.

19. The full duplex recorder of claim 17 further comprising a memory coupled to the information combiner for storing the single stream of encoded information frames.

20. The full duplex recorder of claim 19 further comprising a playback decoder coupled to the memory for retrieving the single stream of encoded information frames and for generating a stream of playback frames from the single stream of encoded information frames.

21. The full duplex recorder of claim 18 further comprising a speaker record decision block coupled to the decoder for generating a speaker record decision signal from the stream of decoded information frames or the first stream of encoded information frames or the additional stream of encoded information frames or the stream of information samples.

22. The full duplex recorder of claim 21 wherein the information combiner selects a recorded information frame from the first stream of encoded information frames in response to the speaker record decision signal.

23. The full duplex recorder of claim 17 further comprising a microphone record decision block coupled to the encoder for generating a microphone record decision signal from the stream of information samples or the encoded information frames or the decoded stream of encoded information frames or the additional stream of encoded information frames.

24. The full duplex recorder of claim 23 wherein the information combiner selects an encoded information frame from the additional stream of encoded information frames in response to the microphone record decision signal.
